(19) United States
(12) Patent Application Publication
(10) Pub. No.: US 2020/0039725 A1
(43) Pub. Date: Feb. 6, 2020

(54) MOISTURE WICKING FOOD CONTAINER

(71) Applicant: Kevin R. Parsons, Davidson, NC (US)

(72) Inventor: Kevin R. Parsons, Davidson, NC (US)

(21) Appl. No.: 16/258,746

(22) Filed: Jan. 28, 2019

Related U.S. Application Data
(60) Provisional application No. 62/713,689, filed on Aug. 2, 2018.

(51) Int. Cl. B65D 81/24; B01J 20/22

(52) U.S. Cl. CPC B65D 81/24; B01J 20/223

(57) ABSTRACT

A food container for wicking moisture from a food product stored in the container including a food receptacle having an interior volume and an opening for permitting a food product to be placed in and removed from the receptacle, a lid adapted for being positioned onto and sealing the opening, a desiccant reservoir positioned on an underside of the lid for being exposed to the interior volume of the receptacle and adapted for containing a desiccant material, and a plurality of apertures in the reservoir for allowing air flow communication between the interior of the receptacle and the reservoir whereby moisture given off by the food product contained in the receptacle is absorbed by the desiccant material to aid in maintaining freshness of the food.

### CROSS REFERENCE TO RELATED PATENT APPLICATIONS

This application claims the benefit of and priority to U.S. Provisional Patent Application No. 62/713,689, filed Aug. 2, 2018, herein expressly incorporated by reference in its entirety.

### TECHNICAL FIELD AND BACKGROUND OF THE INVENTION

The present invention relates to the field of food containers, more specifically, a moisture wicking food container.

Food is often placed into containers for transportation and/or storage. As non-limiting examples, the food may be leftovers from a dine-in restaurant, a pickup order or delivery from a local restaurant, or prepared food from a deli or grocery store. Hot foods release moisture in the form of steam while in the container. Steam condenses on the interior walls of the container due to generally lower temperatures outside of the container. Condensation collects in the bottom of the container and the food sits in the condensation causing the food to lose its crispness and to become soggy. Experimental data has shown that hot foods placed in certain containers may see a rise to more than 85% relative humidity within several minutes of enclosing the food inside of the container.

### SUMMARY OF THE INVENTION

It is therefore an object of the present invention to provide a food container that maintains the crispness and reduces the sogginess of food placed in the container.

It is another object of the present invention to provide a food container for transportation and/or storage of food.

These and other objects and advantages of the present invention are achieved in the preferred embodiments set forth below by providing a food container for wicking moisture from a food product stored in the container including a food receptacle having an interior volume and an opening for permitting a food product to be placed in and removed from the receptacle, a lid adapted for being positioned onto and sealing the opening, a desiccant reservoir positioned on an underside of the lid for being exposed to the interior volume of the receptacle and adapted for containing a desiccant material, and a plurality of apertures in the reservoir for allowing air flow communication between the interior of the receptacle and the reservoir whereby moisture given off by the food product contained in the receptacle is absorbed by the desiccant material to aid in maintaining freshness of the food.

According to another embodiment of the invention, the desiccant reservoir has a cylindrical shape and projects from the underside of the lid in a downward direction towards the receptacle when the lid is positioned on the receptacle.

According to another embodiment of the invention, the desiccant reservoir is smaller in diameter than the lid.

According to another embodiment of the invention, the desiccant reservoir is a foraminous membrane that connects to the underside of the lid and forms a chamber between the membrane and the underside of the lid for holding the desiccant material.

According to another embodiment of the invention, the foraminous membrane is made of a flexible material adapted to enable the membrane to sag due to the weight of the desiccant material for increased surface area to absorb steam.

According to another embodiment of the invention, the desiccant reservoir is detachable from the underside of the lid.

According to another embodiment of the invention, the desiccant reservoir is connected to the underside of the lid by interlocking threads located on the underside of the lid and an upper side of the desiccant reservoir.

According to another embodiment of the invention, the desiccant reservoir has an access opening through the lid for inserting desiccant material into the desiccant reservoir.

According to another embodiment of the invention, the desiccant material is selected from the group consisting of silica gel, calcium chloride, salt, calcium sulfate, calcium oxide, molecular sieve, desiccant clay, and desiccant sheets.

According to another embodiment of the invention, the apertures are smaller than the size of individual granules of the desiccant material to hold the desiccant material inside of the desiccant reservoir.

According to another embodiment of the invention, the desiccant material is contained in a porous package that is placed inside of the desiccant reservoir.

According to another embodiment of the invention, the desiccant material is in a sheet of material and one or more sheets are placed inside of the desiccant reservoir.

According to another embodiment of the invention, the lid is hingedly connected to the food receptacle.

According to another embodiment of the invention, the lid has one or more ventilation openings for allowing steam to exit the container.

According to another embodiment of the invention, a food container is provided for wicking moisture from a food product stored in the container having a food receptacle having an interior volume and an opening for permitting a food product to be placed in and removed from the receptacle, a lid adapted for being positioned onto and sealing the opening, a desiccant reservoir positioned on a portion of a sidewall of the food receptacle for being exposed to the interior volume of the receptacle and adapted for containing a desiccant material, and a plurality of apertures in the reservoir for allowing air flow communication between the interior of the receptacle and the reservoir whereby moisture given off by the food product contained in the receptacle is absorbed by the desiccant material to aid in maintaining freshness of the food.

According to another embodiment of the invention, a food container is provided for wicking moisture from a food product stored in the container having a food receptacle having an interior volume and an opening for permitting a food product to be placed in and removed from the receptacle, a lid adapted for being positioned onto and sealing the opening, a desiccant reservoir having a cylindrical shape positioned on an underside of the lid and projects in a downward direction towards the receptacle when the lid is positioned on the receptacle for being exposed to the interior volume of the receptacle and adapted for containing a desiccant material, and a plurality of apertures in the reservoir for allowing air flow communication between the interior of the receptacle and the reservoir whereby moisture given off by the food product contained in the receptacle is absorbed by the desiccant material to aid in maintaining freshness of the food.

### BRIEF DESCRIPTION OF THE DRAWING FIGURES

The present invention is best understood when the following detailed description of the invention is read with reference to the accompanying drawings, in which:

FIG. 1 is a perspective view of a moisture wicking food container;

FIG. 2 is a cross section perspective view of the food container shown in FIG. 1;

FIG. 3 is a cross section view of an alternative embodiment of a food container with a foraminous membrane;

FIG. 4 is a cross section view of an alternative embodiment of the food container shown in FIG. 3 with a sagging foraminous membrane;

FIG. 5 is a perspective view of an alternative embodiment of a food container with a hinged lid;

FIG. 6 is a perspective view of an alternative embodiment of a food container with foldable lid flaps;

FIG. 7 is a perspective view of an alternative embodiment of a food container where a desiccant reservoir is located in a food receptacle;

FIG. 8 is a partial perspective view of an alternative embodiment of a food container where a side access opening is located on a desiccant reservoir;

FIG. 9 is a partial perspective view of an alternative embodiment of a food container where a top access opening is located on a desiccant reservoir and top;

FIG. 10 is a partial perspective view of an alternative embodiment of a food container where a desiccant reservoir is threaded into a lid;

FIG. 11 is a partial perspective view of an alternative embodiment of a food container having ventilation holes;

FIG. 12 is a partial perspective view of an alternative embodiment of a food container with a porous packaged desiccant; and

FIG. 13 is a partial perspective view of an alternative embodiment of a food container with multiple desiccant sheets.

### DETAILED DESCRIPTION OF THE PREFERRED EMBODIMENT

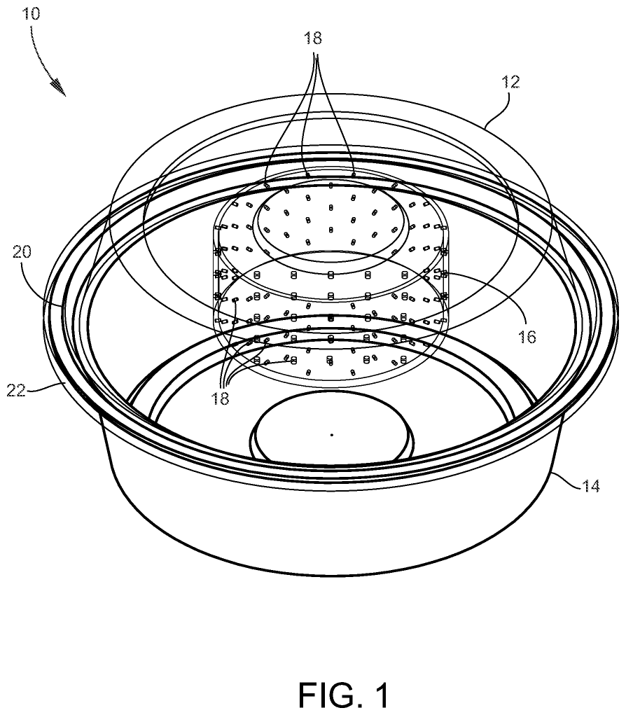

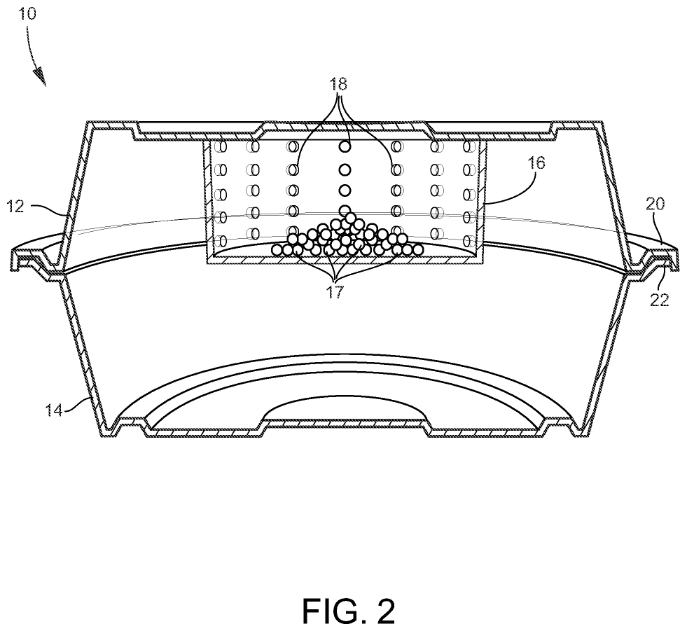

Referring now to the drawings, a moisture wicking food container 10 is shown in FIGS. 1 and 2. The food container 10 has a food receptacle 14 into which food can be placed for storage and/or transport. A lid 12 is placed on and sealed to the food receptacle 14 by connecting a lid flange 20 to a food receptacle flange 22 located along the rim of the food receptacle 14. A desiccant reservoir 16 is connected to the underside of the lid 12 such that the desiccant reservoir 16 is suspended partially inside of the food container 10 when the lid 12 is sealed onto the food receptacle 14. The desiccant reservoir 16 holds a desiccant material 17 and has a plurality of apertures 18 that allow the desiccant material 17 to be exposed to the interior of the food container 10 and absorb moisture from inside of the food container 10. The desiccant reservoir 16 prevents desiccant material 17 from making contact with the food product while allowing the moisture released by the food product in the form of steam to be absorbed in order to prevent the food from becoming soggy. The desiccant reservoir 16 is shown centered on the underside of the lid 12 with a cylindrical shape in the embodiment of FIGS. 1 and 2, however the desiccant reservoir 16 can be located in any position on the underside of the lid 12 and have other shapes.

Desiccant material 17 is a moisture absorbing material. The amount and type of desiccant material 17 depends on many factors such as the size of the container, the type and value of the food, anticipated temperature and moisture content of the food, and desired humidity reduction rate. Typically, non-toxic food grade desiccant material 17 will be required due to safety and regulatory factors. Examples of desiccant material 17 include, but are not limited to, calcium chloride, salt, sucrose, silica gel, calcium sulfate, calcium oxide, molecular sieve, desiccant clay, and desiccant sheets of a semi-rigid matrix of cellulose fiber (for example Novo-Dry™). Experimental data has shown that certain hot food products placed in a container without desiccant material 17 experience a resulting 85% or higher relative humidity. That same food product placed in a similar sized container with 200 g of calcium chloride or 200 g or silica gel saw a reduction in humidity to approximately 30% relative humidity within 10 minutes of closing the container. 100 g of silica gel showed a reduction in relative humidity to under 50% within the same amount of time.

The desiccant material 17 can be placed directly into the desiccant reservoir 16 as a loose material, secondarily packaged in porous packets, or be in the form of one or more desiccant sheets. Desiccant material 17 can come pre-filled within the desiccant reservoir 16 or the desiccant reservoir 16 can have some other way for desiccant material 17 to be inserted using, for example, an access opening. When loose desiccant material 17 is used, the apertures 18 must be smaller in relation to the size of the individual granules of the desiccant material 17 to prevent any contamination of the food product. Secondarily packaged porous packets of desiccant material 17 enable much smaller granules of desiccant material 17 to be utilized. The quantity and placement of apertures 18 must allow for steam to enter the desiccant reservoir 16 such that the steam has access to desiccant material 17 from multiple sides.

The food container 10 can have many different sizes, shapes, configurations, and be made from different materials depending on the type of food, amount of food, and other factors. Examples of materials include foam, plastic, cardboard, or combinations thereof. The materials can also include insulating properties and leak-proof properties. Dividers within the food receptacle 14 can enable multiple food products to be placed within the food receptacle 14. The lid 12 can be a separate detachable part as shown in the FIG. 1 embodiment that fastens to the food receptacle 14 by way of interlocking flanges 20, 22 on the lid 12 and food receptacle 14. Other fastening methods such as tabs, overhangs, interlocking threads, adhesives, and other fasteners are also available. The lid 12 and food receptacle 14 can also be one piece connected by a hinge or a folding boundary.

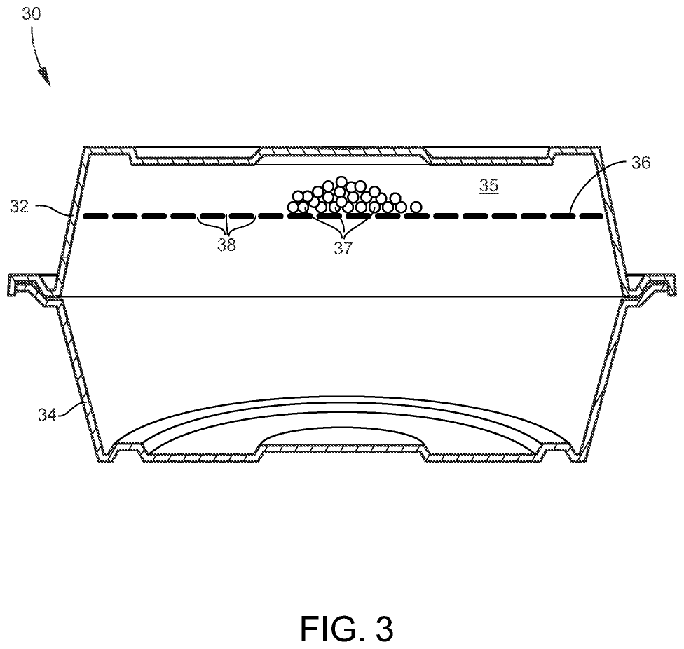

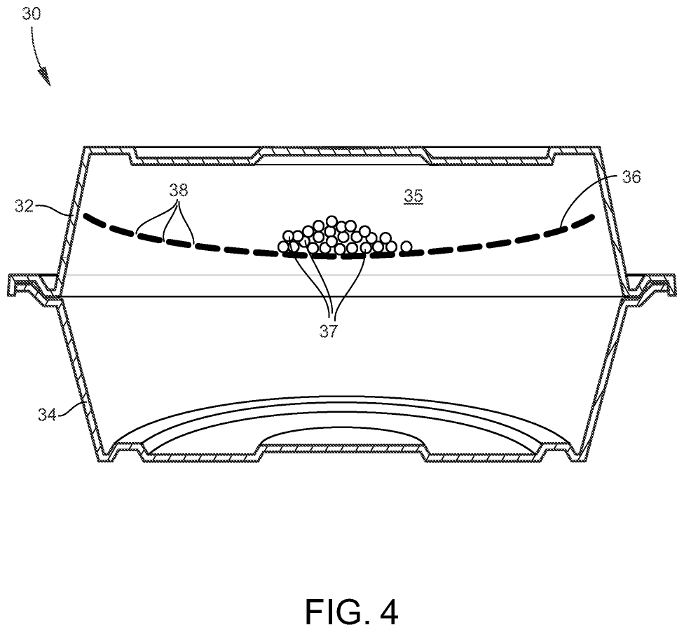

FIGS. 3 and 4 show a moisture wicking food container 30 with a food receptacle 34 to hold food product and a lid 32 to cover and seal the food receptacle 34. A foraminous membrane 36 spans at least a portion of the underside of the lid 32 creating a desiccant reservoir chamber 35 to hold the desiccant material 37. The membrane 36 has a plurality of apertures 38 that enable the desiccant material 37 to absorb steam from the food product placed into the receptacle 34. The membrane 36 can be stretched taut on the underside of the lid 32 and made of a material that is rigid, resilient, flexible, or a combination thereof. FIG. 3 shows the membrane 36 in a taut or rigid configuration while FIG. 4 shows the membrane 36 in a flexible or sagging configuration. The sagging configuration of the membrane 36 enables more surface area of desiccant material 37 to be exposed to the steam in order to maximize absorption.

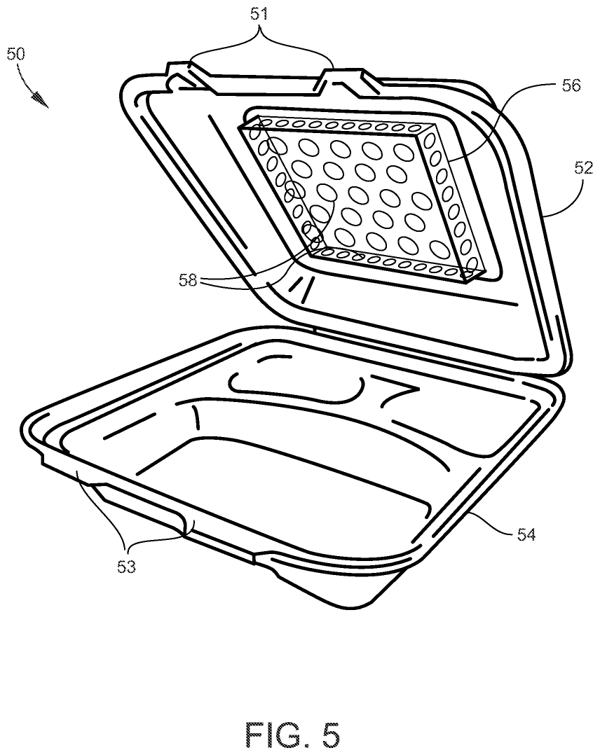

FIG. 5 shows a moisture wicking food container 50 that has a food receptacle 54 hingedly connected to a lid 52. Sets of lid tabs 51 and food receptacle tabs 53 connect to allow the food container 50 to be closed. A desiccant reservoir 56 projects from the underside of the lid 52 and has a plurality of apertures 58. Desiccant material is placed inside of the desiccant reservoir 56. Steam from hot food product placed in the food receptacle 54 is able to rise through the apertures 58 and be absorbed by the desiccant material. While the desiccant reservoir 56 is shown having a square shape, other shapes such as a cylinder similar to the embodiment of FIG. 1 are also envisioned.

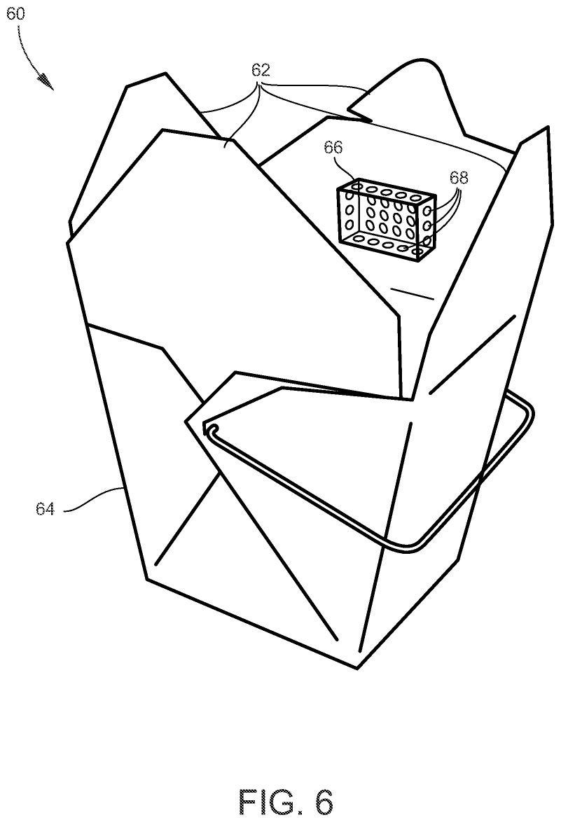

FIG. 6 shows a moisture wicking food container 60 similar to the design colloquially called “Chinese take-out boxes”. In this embodiment, a food receptacle 64 and a lid 62 are one integrated piece that folds into the shape of the food container 60. The lid 62 consists of four flaps that interlock when folded to seal the food receptacle 64. A desiccant reservoir 66 having a plurality of apertures 68 can be attached to the inside or underside of one of the lid flaps 62 such that when the lid flaps 62 are folded to seal the container 60 desiccant material inside of the desiccant reservoir 66 is exposed to the steam rising from food product inside of the food receptacle 64 through the apertures 68. The desiccant reservoir 66 can alternatively be placed on an inside surface of the food receptacle 64 itself.

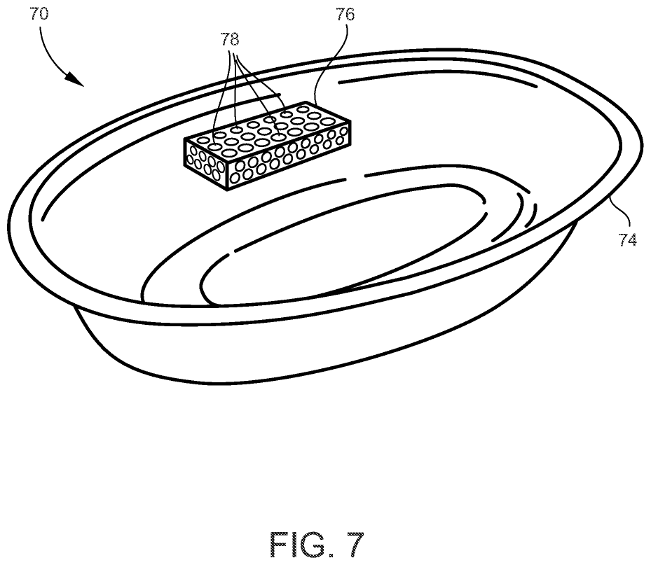

FIG. 7 shows a moisture wicking food container 70 where a desiccant reservoir 76 is attached to an inside sidewall surface of a food receptacle 74. The desiccant reservoir 76 has a plurality of apertures 78 that enable desiccant material placed inside of the desiccant reservoir 76 to absorb steam rising from food product placed inside of the food receptacle 74. A lid (not shown) can be in the form of any of the previously disclosed embodiments or can simply be a disposable covering such as plastic wrap or aluminum foil. In this embodiment, the desiccant reservoir 76 is shown to be placed closed to the upper rim of the food receptacle 74 and only extend along a portion of the circumference of the rim. Alternatively, the desiccant reservoir 76 can extend along a larger amount of the circumference of the rim.

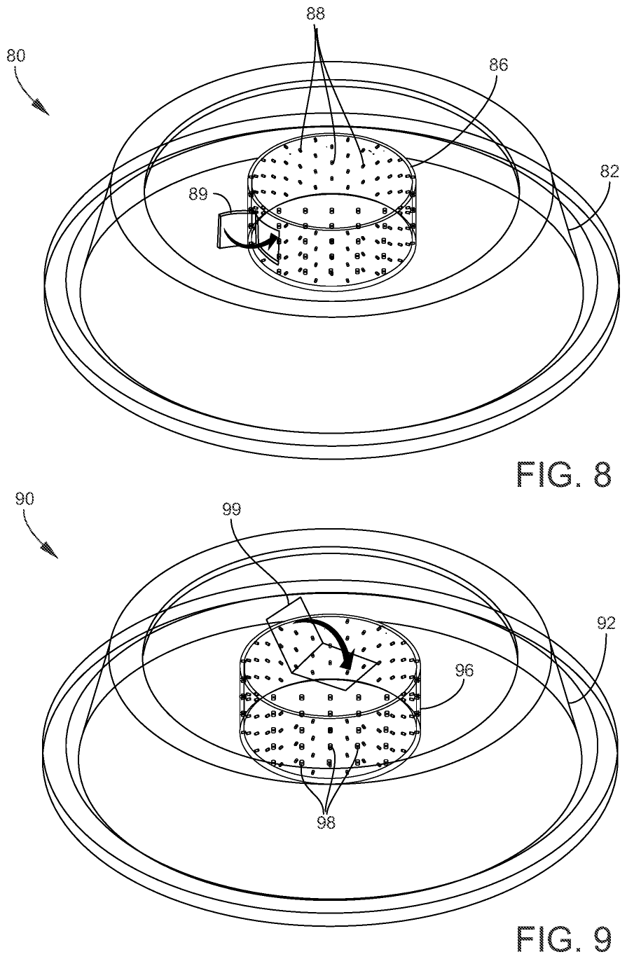

FIGS. 8 and 9 show two alternative embodiments 80, 90 of lids 92, 82 having desiccant reservoirs 86,96 with access openings 89,99 for inserting desiccant material. In FIG. 8, the access opening 89 is located on the desiccant reservoir 86 sidewall to enable desiccant material to be placed inside. FIG. 9 shows an access opening 99 located through the lid 92 and accessible on the topside of the lid 92. In both the FIG. 8 and FIG. 9 embodiments, the desiccant reservoirs 86, 96 have a plurality of apertures 88, 99 and are attached on undersides of their respective lids 82, 92. The openings 89, 99 can be repeatedly opened and closed for insertion and removal of the desiccant material. These openings 89, 99 are simple hinged flaps but other openings such as slots, adhesive doors, screw/bolted, nailed doors, and others are envisioned.

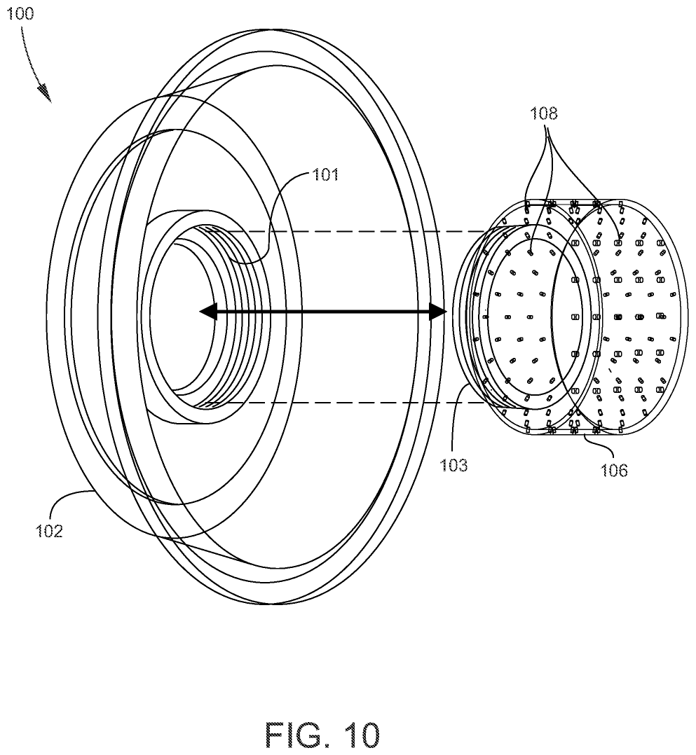

FIG. 10 shows an alternative embodiment 100 with a desiccant reservoir 106 that has a plurality of apertures 108 that is fastened onto an underside of a lid 102. The lid 102 has a threaded indentation 101 that receives and interlocks with a threaded end 103 of the desiccant reservoir 106. The desiccant reservoir 106 having a plurality of apertures 108 can be filled with desiccant material and twisted into the lid 102. Fastening methods such as folding tabs, adhesives, snapping indentations, and other methods are also envisioned.

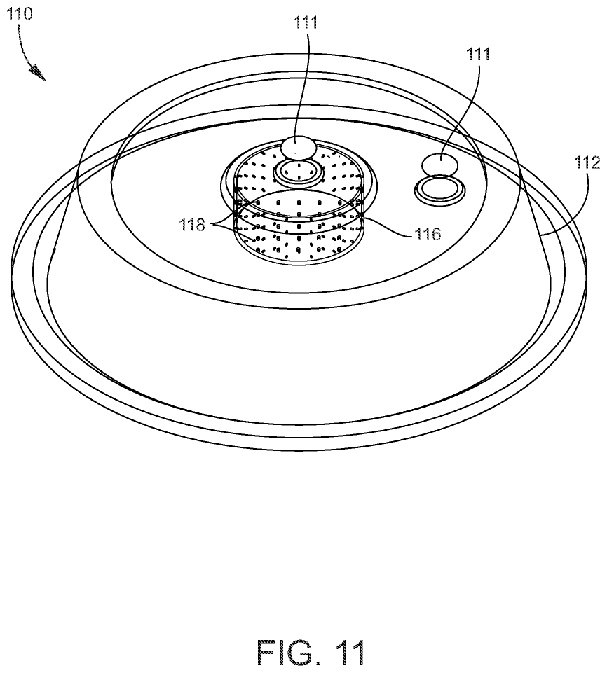

FIG. 11 shows an alternative embodiment 110 with a lid 112 having ventilation holes 111. The holes 111 are pre-punched and can be opened to allow steam to escape from the food container 110. While FIG. 11 shows two holes 111, other embodiments can have only a single hole 111 or have a plurality of holes 111. The holes 111 can be pre-cut openings that do not require later opening. The shape of the holes 111 can be in the form of circles, ovals, slits, or any other suitable shapes. One of the holes 111 can be, as shown in FIG. 11, located on a topside of the lid 112 above where a desiccant reservoir 116 having a plurality of apertures 118 is located. The location of the holes 111 can be determined based on a variety of factors such as aesthetics, manufacturing ease/cost, optimization for the type of food, as well as other factors.

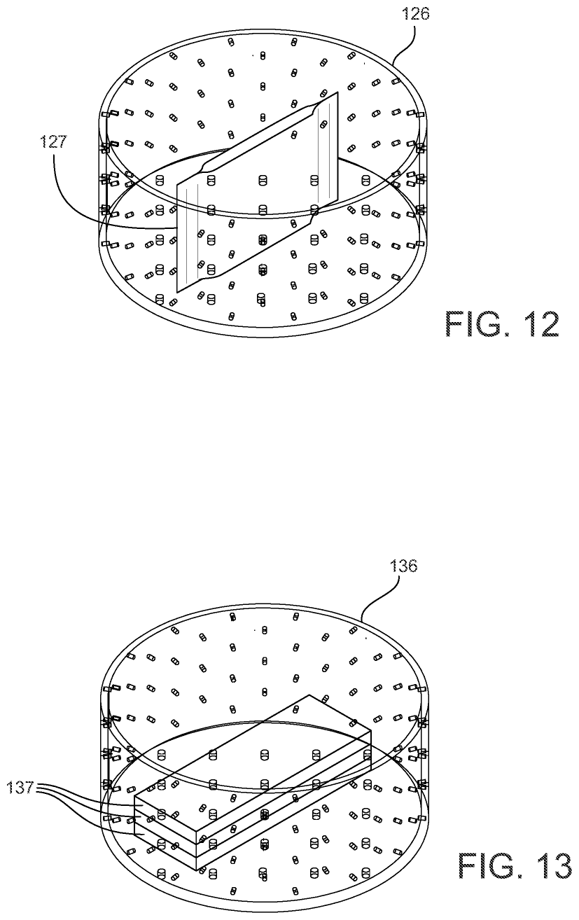

FIGS. 12 and 13 show alternative embodiments of the desiccant material 127,137 contained within the desiccant reservoir 126, 136. In FIG. 12, the desiccant material 127 is in the form of porous packages containing desiccant material. For example, silica gel packets can be used. The desiccant material is in the form of desiccant sheets 137 in FIG. 13. One or more desiccant sheets 137 can be inserted into the desiccant reservoir 136. These sheets 137 are a web of desiccant absorbent particles contained within a semi-rigid matrix of cellulose fiber. An example of this is a product called Novo-Dry™.

A moisture-wicking food container according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

1. A food container for wicking moisture from a food product stored in the container, comprising:
(a) a food receptacle having an interior volume and an opening for permitting a food product to be placed in and removed from the receptacle;
(b) a lid adapted for being positioned onto and sealing the opening;
(c) a desiccant reservoir positioned on an underside of the lid for being exposed to the interior volume of the receptacle and adapted for containing a desiccant material; and
(d) a plurality of apertures in the reservoir for allowing air flow communication between the interior of the receptacle and the reservoir whereby moisture given off by the food product contained in the receptacle is absorbed by the desiccant material to aid in maintaining freshness of the food.

2. A food container according to claim 1, wherein the desiccant reservoir has a cylindrical shape and projects from the underside of the lid in a downward direction towards the receptacle when the lid is positioned on the receptacle.

3. A food container according to claim 1, wherein the desiccant reservoir is smaller in diameter than the lid.

4. A food container according to claim 1, wherein the desiccant reservoir is a foraminous membrane that connects to the underside of the lid and forms a chamber between the membrane and the underside of the lid for holding the desiccant material.

5. A food container according to claim 4, wherein the foraminous membrane is made of a flexible material adapted to enable the membrane to sag due to the weight of the desiccant material for increased surface area to absorb steam.

6. A food container according to claim 1, wherein the desiccant reservoir is detachable from the underside of the lid.

7. A food container according to claim 1, wherein the desiccant reservoir is connected to the underside of the lid by interlocking threads located on the underside of the lid and an upper side of the desiccant reservoir.

8. A food container according to claim 1, wherein the desiccant reservoir has an access opening through the lid for inserting desiccant material into the desiccant reservoir.

9. A food container according to claim 1, wherein the desiccant material is selected from the group consisting of silica gel, calcium chloride, salt, calcium sulfate, calcium oxide, molecular sieve, desiccant clay, and desiccant sheets.

10. A food container according to claim 1, wherein the apertures are smaller than individual granules of the desiccant material to hold the desiccant material inside of the desiccant reservoir.

11. A food container according to claim 1, wherein the desiccant material is contained in a porous package that is placed inside of the desiccant reservoir.

12. A food container according to claim 1, wherein the desiccant material is in a sheet of material and one or more sheets are placed inside of the desiccant reservoir.

13. A food container according to claim 1, wherein the lid is hingedly connected to the food receptacle.

14. A food container according to claim 1, wherein the lid has one or more ventilation openings for allowing steam to exit the container.

15. A food container for wicking moisture from a food product stored in the container, comprising:
(a) a food receptacle having an interior volume and an opening for permitting a food product to be placed in and removed from the receptacle;
(b) a lid adapted for being positioned onto and sealing the opening;
(c) a desiccant reservoir positioned on a portion of a sidewall of the food receptacle for being exposed to the interior volume of the receptacle and adapted for containing a desiccant material; and
(d) a plurality of apertures in the reservoir for allowing air flow communication between the interior of the receptacle and the reservoir whereby moisture given off by the food product contained in the receptacle is absorbed by the desiccant material to aid in maintaining freshness of the food.

16. A food container for wicking moisture from a food product stored in the container, comprising:
(a) a food receptacle having an interior volume and an opening for permitting a food product to be placed in and removed from the receptacle;
(b) a lid adapted for being positioned onto and sealing the opening;
(c) a desiccant reservoir having a cylindrical shape positioned on an underside of the lid and projects in a downward direction towards the receptacle when the lid is positioned on the receptacle for being exposed to the interior volume of the receptacle and adapted for containing a desiccant material; and
(d) a plurality of apertures in the reservoir for allowing air flow communication between the interior of the receptacle and the reservoir whereby moisture given off by the food product contained in the receptacle is absorbed by the desiccant material to aid in maintaining freshness of the food.
